(19) United States
(12) Patent Application Publication
(10) Pub. No.: US 2022/0094803 A1
(43) Pub. Date: Mar. 24, 2022

(54) HINGE ASSEMBLIES FOR IMAGE FORMING APPARATUSES

(71) Applicants: Shuang-Kun ZHU, Shanghai (CN); Yu-Mao ZHU, Shanghai (CN); Jian-Ye TANG, Shanghai (CN); Hewlett-Packard Development Company, L.P., Spring, TX (US)

(72) Inventors: Shuang-Kun Zhu, Shanghai (CN); Yu-Mao Zhu, Shanghai (CN); Jianye Tang, Shanghai (CN)

(73) Assignee: Hewlett-Packard Development Company, L.P., Spring, TX (US)

(21) Appl. No.: 17/423,962

(22) PCT Filed: May 15, 2019
(86) PCT No.: PCT/CN2019/087056

§ 371 Date: Jul. 19, 2021

(51) Int. Cl. H04N 1/00; G06F 1/16

(52) U.S. Cl. CPC H04N 1/00554; G06F 1/1681

(57) ABSTRACT

An hinge assembly for an image forming apparatus comprises a hinge case (102), an elastic member (104) disposed in the hinge case (102), a first sliding member (106) to engage with a first side of the elastic member (104), a second sliding member (108) to engage with a second side of the elastic member. Further, the hinge assembly may comprise a first hinge arm (110) to engage with the first sliding member (106) such that the first sliding member (106) may compressively engage with the elastic member (104) during rotation of the first hinge arm (110) relative to the hinge case (102). Furthermore, the hinge assembly may comprise a second hinge arm (112) to engage with the second sliding member (108) such that the second sliding member (108) may compressively engage with the elastic member (104) during rotation of the second hinge arm (112) relative to the hinge case (102). An image forming apparatus comprising the hinge assembly also is described. The hinge assembly can pivotally connect the scanner assembly and the cover member to the main body, and thereby enhancing the user experience and reducing the cost.

### BACKGROUND

Multifunction machines may include an upper unit having a scanner function that is rotatably attached to a main body having a printer function. The upper unit may be disposed on the main body to expose and cover an access opening formed in an upper surface of the main body. The upper unit can be rotated to an open position relative to the main body to expose the access opening, thereby enabling to remove a cartridge or a paper from or insert a cartridge into the main body through the access opening. The upper unit may include a scanner assembly (e.g., an integrated scanner assembly (ISA)) including a platen on which a document may be placed and a cover member (e.g., an automatic document feeder (ADF)) that covers the platen. The cover member may be pivoted to an open position to expose the platen (e.g., to place a document on the platen), and to a closed position to cover the platen.

### BRIEF DESCRIPTION OF THE DRAWINGS

Examples are described in the following detailed description and in reference to the drawings, in which:

FIG. 1 is a schematic view of an example hinge assembly, depicting an elastic member to support first and second hinge arms;

FIG. 2 is an exploded view of the example hinge assembly of FIG. 1, depicting additional features;

FIG. 3A depicts a schematic representation of an example hinge case, an example first sliding member, and an example second sliding member;

FIG. 3B depicts an example schematic representation of the first sliding member and the second sliding member disposed in the hinge case via respective one of first and second groove features;

FIG. 4 is a schematic diagram of an example image forming apparatus including a hinge assembly to rotatably couple a scanner assembly and a cover member to a main body;

FIG. 5 is a schematic diagram of the example image forming apparatus of FIG. 4, depicting a mechanism for holding an upper unit in an open position;

FIG. 6 is a schematic diagram of the example image forming apparatus of FIG. 4, depicting a mechanism for holding the cover member in an open position;

FIG. 7 illustrate a schematic diagram of an example hinge case, a first hinge arm, and a second hinge arm of FIG. 4, depicting additional features;

FIG. 8 is a schematic diagram of another example image forming apparatus including a hinge assembly to rotatably couple a scanner assembly and a cover member to a main body; and

FIGS. 9A-9I depict schematic diagrams of an example installation mechanism to install a hinge assembly into an image forming apparatus including an upper unit and a main body.

### DETAILED DESCRIPTION

Multifunction machines may include an upper unit having a scanner function that may be rotatably attached to a main body having a printer function. The upper unit may be disposed on the main body to expose and cover an access opening formed in an upper surface of the main body. The upper unit can be rotated to an open position relative to the main body to expose the access opening, thereby enabling services such as removing a cartridge or a small size paper (e.g., jammed paper) from, or inserting a cartridge into the main body. The upper unit may include a scanner assembly (e.g., an integrated scanner assembly (ISA)) including a platen on which a document can be placed and a cover member (e.g., an automatic document feeder (ADF)) that covers the platen. The cover member may be pivoted to an open position to expose the platen (e.g., to place a document on the platen), and to a closed position to cover the platen.

Some example multifunctional printers may include two damper hinges, for instance, an ISA hinge and an ADF hinge. The ISA hinge may support rotation of the upper unit including the ISA and hold the upper unit in the open position. The ADF hinge may support rotation of the cover member (i.e., the ADF) and hold the cover member in the open position. Some other multifunctional printers may include one damper hinge, i.e., the ISA hinge. The damper hinge may support the upper unit in the open position. However, multifunctional printers with one damper hinge may not have damper hinge for the ADF. Such multifunctional printers may affect the user experience during opening and closing of the ADF due to lack of dampers. In some other examples, multifunctional printers may be provided with pocket features to accommodate the hinge assembly, which may affect industrial design.

Examples described herein may provide a hinge assembly for an image forming apparatus. The hinge assembly may include a hinge case secured to a scanner assembly, an elastic member disposed in the hinge case, and first and second sliding members engaged with the elastic member on opposite sides. Furthermore, the hinge assembly may include a first hinge arm secured to a main body and engaged with the first sliding member. Also, the hinge assembly may include a second hinge arm secured to a cover member and engaged with the second sliding member.

During closing of the upper unit relative to the main body, the first sliding member may move horizontally to generate an elastic force via compression of the elastic member in order to hold the upper unit in an open position. During the closing of the cover member relative to the scanner assembly, the second sliding member may move horizontally to generate an elastic force via compression of the elastic member in order to hold the cover member in an open position.

Thus, examples described herein may provide a common elastic member (i.e., a common spring) to support two hinge arms to enable multiple functions for the hinge assembly. One function may be to support the ADF, while another function may be to support the ISA assembly. Thus, examples described herein may provide a common hinge assembly to pivotally connect the scanner assembly and the cover member to the main body.

Examples described herein may utilize released and stored energy of the elastic member during the opening and closing processes of the image processing apparatus at a specific angle range. Thus, examples described herein may realize the feeling of “opening the light and closing the weight” in the opening and closing processes of the image processing apparatus, and thereby enhancing the user experience.

Examples described herein may eliminate the separate ADF hinge on the multifunctional machines, thereby reducing the cost. The hinge assembly described herein may also act as a damper for opening and closing the ADF, thereby enhancing user experience. Examples described herein may enhance the industrial design as separate pocket features may not be needed to accommodate the hinge assembly. Also, examples described herein may optimize the hinge assembly integration process.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described may be included in at least that one example, but not necessarily in other examples.

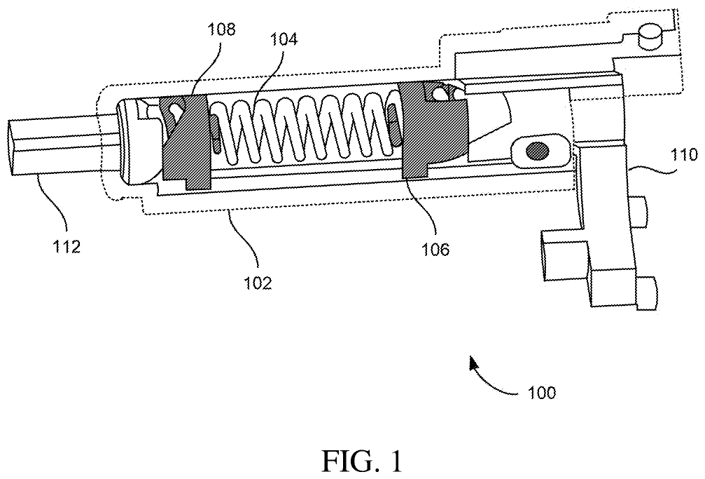

Referring now to the figures, FIG. 1 is a schematic view of an example hinge assembly 100, depicting an elastic member 104 to support first and second hinge arms 110 and 112. Hinge assembly 100 may pivotally connect a first rotating member (e.g., an ISA) and a second rotating member (e.g., an ADF) to a main body of an image forming apparatus.

Example hinge assembly 100 may include a hinge case 102. Hinge case 102 may be fixedly secured to the first rotating member. Further, hinge assembly 100 may include elastic member 104 disposed in hinge case 102. Example elastic member 104 may be a compression spring. In some examples, elastic member 104 may have any other structure and configurations while ensuring the function of elastic member 104.

Further, hinge assembly 100 may include a first sliding member 106 to engage with a first side of elastic member 104. Hinge assembly 100 may include a second sliding member 108 to engage with a second side of elastic member 104. The second side may be opposite to the first side.

Also, hinge assembly 100 may include first hinge arm 110 to engage with first sliding member 106 such that first sliding member 106 may compressively engage with elastic member 104 during rotation of first hinge arm 110 relative to hinge case 102. First hinge arm 110 may be fixedly secured to the main body.

In addition, hinge assembly 100 may include second hinge arm 112 to engage with second sliding member 108 such that second sliding member 108 may compressively engage with elastic member 104 during rotation of second hinge arm 112 relative to hinge case 102. Second hinge arm 112 may be fixedly secured to the second rotating member.

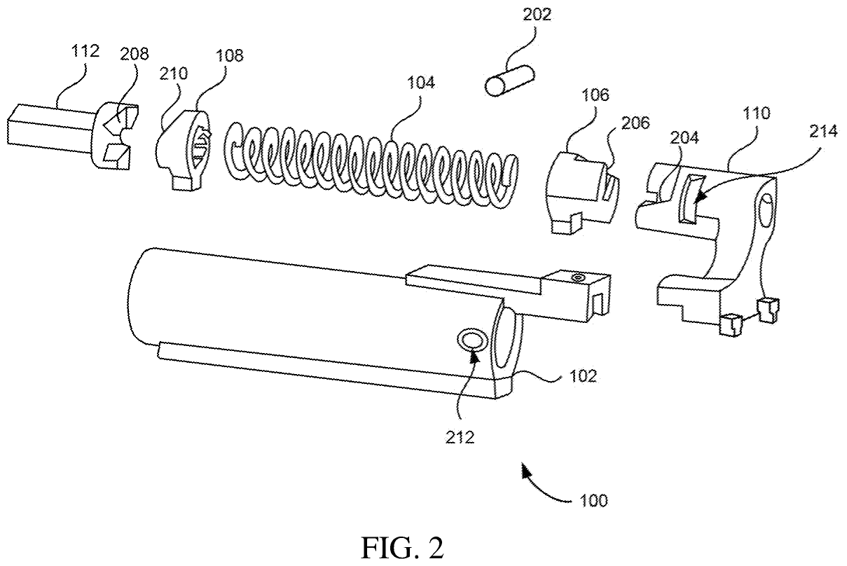

FIG. 2 is an exploded view of example hinge assembly 100 of FIG. 1, depicting additional features. For example, similarly named elements of FIG. 2 may be similar in structure and/or function to elements described with respect to FIG. 1. As shown in FIG. 2, first hinge arm 110 may include a first sliding feature 204 and first sliding member 106 may include a second sliding feature 206. In this example, first hinge arm 110 may physically engage with first sliding member 106 via first sliding feature 204 and second sliding feature 206.

Also, as shown in FIG. 2, second hinge arm 112 may include a third sliding feature 208 and second sliding member 108 may include a fourth sliding feature 210. In this example, second hinge arm 112 may physically engage with second sliding member 108 via third sliding feature 208 and fourth sliding feature 210.

Also, hinge assembly 100 may include a hinge pin 202 engaged with hinge case 102 and first hinge arm 110 to enable rotation of first hinge arm 110 relative to hinge case 102 and to restrain a horizontal movement of first hinge arm 110. In one example, hinge case 102 may include an opening 212 and first hinge arm 110 may include an elongated vertical opening 214. Hinge pin 202 may be engaged with hinge case 102 and first hinge arm 110 via opening 212 and elongated vertical opening 214, respectively, to enable rotation of first hinge arm 110 relative to hinge case 102.

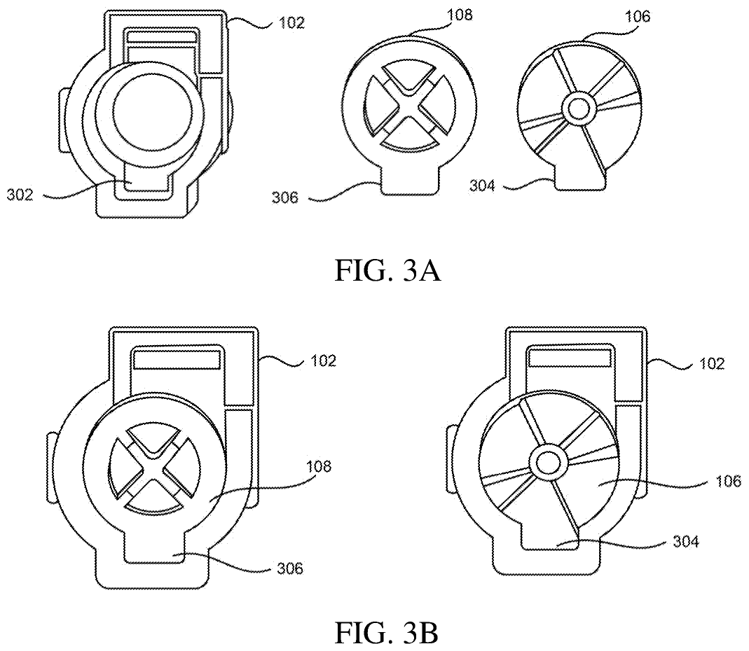

FIG. 3A depicts a schematic representation of example hinge case 102 and example first and second sliding members 106 and 108. For example, similarly named elements of FIGS. 3A and 3B may be similar in structure and/or function to elements described with respect to FIG. 1. As shown in FIG. 3A, hinge case 102 may include a first groove feature 302 and a second groove feature on opposite sides of hinge case 102. Further, first sliding member 106 may include a first protruding feature 304. Second sliding member 108 may include a second protruding feature 306.

In one example, first protruding feature 304 may mate with first groove feature 302 such that first sliding member 106 may slide horizontally within hinge case 102 during rotation of first hinge arm 110. In another example, second protruding feature 306 may mate with the second groove feature such that second sliding member 108 may slide horizontally within hinge case 102 during rotation of second hinge arm 112.

FIG. 3B depicts an example schematic representation of first sliding member 106 and second sliding member 108 disposed in hinge case 102 via respective one of first groove feature 302 and the second groove feature. First groove feature 302 and the second groove feature may guide first sliding member 106 and second sliding member 108 to move horizontally inside hinge case 102. Protruding features 304 and 306 may mate with respective groove features of hinge case 102 to constrain rotation of first sliding member 106 and second sliding member 108 relative to hinge case 102, and enable horizontal movement of first sliding member 106 and second sliding member 108 inside hinge case 102.

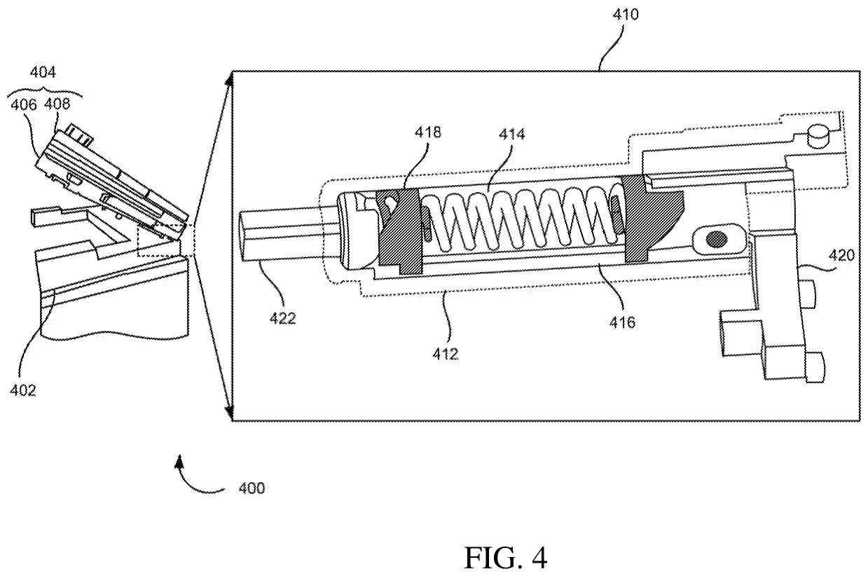

FIG. 4 is a schematic diagram of an example image forming apparatus 400 including a hinge assembly 410 to rotatably couple scanner assembly 406 and a cover member 408 to a main body 402. Example image forming device 400 may have a printer function, a scanner function, a copy function, a facsimile function, or any combination thereof.

As shown in FIG. 4, image forming apparatus 400 may include main body 402, and an upper unit 404 disposed above main body 402. For example, image forming apparatus 400 may achieve the printer function through main body 402, the scanner function through upper unit 404, and the copier function through a combination of these functions.

Main body 402 may be provided with an ink-jet printer. Upper unit 404 may be provided with scanner assembly 406 including a flat-bed scanner (e.g., a platen on which a document can be placed and a scanning member that reads images from the document). Further, an access opening for maintenance may be formed in an upper surface of main body 402. Upper unit 404 may include scanner assembly 406 and cover member 408 disposed on scanner assembly 406.

Further, image forming apparatus 400 may include hinge assembly 410 to pivotably connect scanner assembly 406 (or upper unit 404) and cover member 408 to main body 402 between a closed position and an open position. Upper unit 404 can be opened to access the access opening, for instance, to replace cartridge and cover member 408 can be opened to access the flat-bed scanner in scanner assembly 406. Cover member 408 may include a lower surface, which faces the flat-bed scanner when cover member 408 is in the closed position.

Hinge assembly 410 may include a hinge case 412 secured to scanner assembly 406. Further, hinge assembly 410 may include an elastic member 414 disposed in hinge case 412. Furthermore, hinge assembly 410 may include first and second sliding members 416 and 418 engaged with elastic member 414 on opposite sides. Also, hinge assembly 410 may include a first hinge arm 420 secured to main body 402 and engaged with first sliding member 416. In addition, hinge assembly 410 may include a second hinge arm 422 secured to cover member 408 and engaged with second sliding member 418.

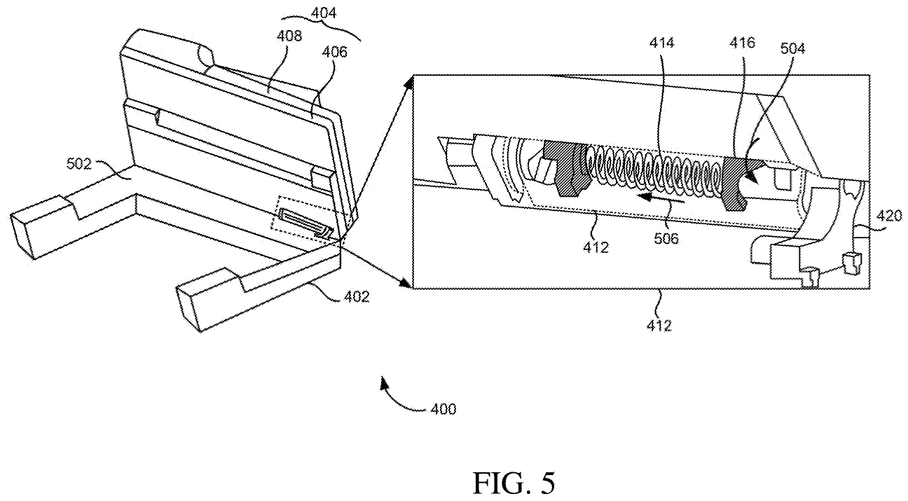

FIG. 5 is a schematic diagram of example image forming apparatus 400 of FIG. 4, depicting a mechanism for holding upper unit 404 in an open position. For example, similarly named elements of FIG. 5 may be similar in structure and/or function to elements described with respect to FIG. 4. As shown in FIG. 5, first hinge arm 420 and first sliding member 416 may include a first sliding feature and a second sliding feature, respectively. First hinge arm 420 may be physically engaged with first sliding member 416 via the first sliding feature and the second sliding feature such that elastic member 414 can generate an elastic force to hold upper unit 404 in an open position. A maximum opening angle of upper unit 404 with respect to main body 402 may be an acute angle (i.e., less than 90°).

In one example, first hinge arm 420 may be fixed to a top cover 502 of main body 402 and hinge case 412 may be fixed to scanner assembly 406. When upper unit 404 including scanner assembly 406 and cover member 408 is in the open position, a gravity force of upper unit 404 may cause hinge case 412 to rotate in a direction shown by an arrow 504. During rotation of hinge case 412, first sliding member 416 may tend to move along the direction shown by an arrow 506 to compress elastic member 414. However, elastic member 414 may generate a spring force to stop the movement of first sliding member 416. Thus, upper unit 404 can be held stably in an open position depending on the spring force.

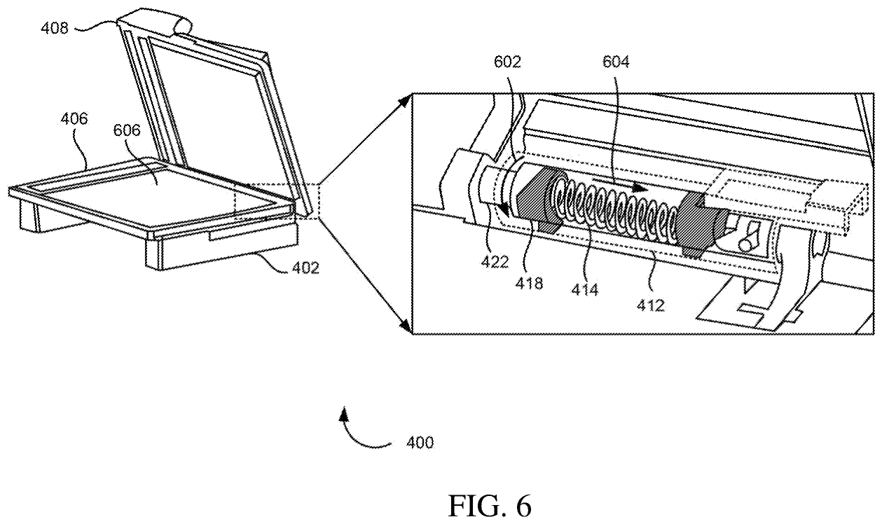

FIG. 6 is a schematic diagram of example image forming apparatus 400 of FIG. 4, depicting a mechanism for holding cover member 408 in an open position. For example, similarly named elements of FIG. 6 may be similar in structure and/or function to elements described with respect to FIG. 4. As shown in FIG. 6, second hinge arm 422 and second sliding member 418 may include a third sliding feature and a fourth sliding feature, respectively. Second hinge arm 422 may be physically engaged with second sliding member 418 via third sliding feature and fourth sliding feature such that elastic member 414 can generate an elastic force to hold cover member 408 in an open position.

In one example, second hinge arm 422 may be fixed to cover member 408. For example, cover member 408 may include an adapter portion to fixedly hold one end of second hinge arm 422. When cover member 408 is in an open position, a gravity force of cover member 408 may cause second hinge arm 422 to rotate in a direction shown by an arrow 602. During rotation of second hinge arm 422 relative to hinge case 412, second sliding member 418 may tend to move along the direction shown by an arrow 604 to compress elastic member 414. However, elastic member 414 may generate a spring force to stop the movement of second sliding member 418. Thus, cover member 408 can be held stably in an open position depending on the spring force to access a flat-bed scanner 606 in scanner assembly 406.

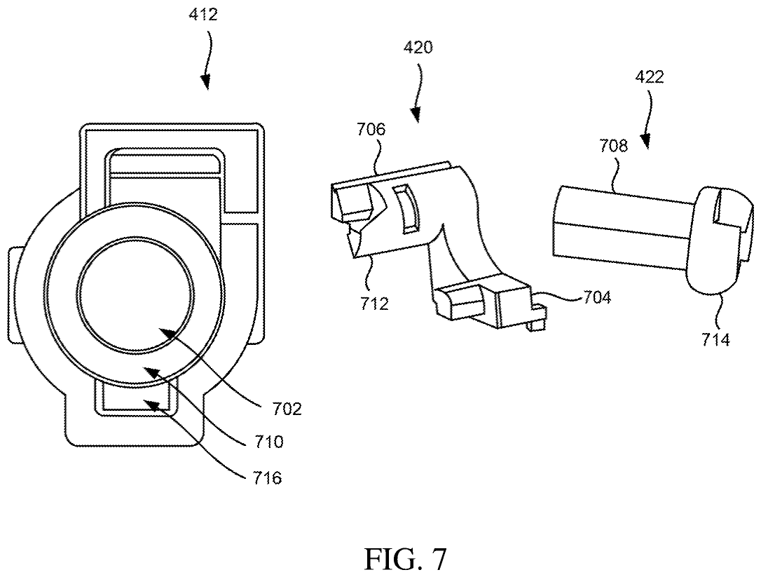

FIG. 7 illustrate a schematic diagram of example hinge case 412, first hinge arm 420, and second hinge arm 422, depicting additional features. For example, similarly named elements of FIG. 7 may be similar in structure and/or function to elements described with respect to FIG. 4. As shown in FIG. 7, hinge case 412 may include an opening 702 (e.g., a through-hole) to rotatably support first hinge arm 420 and second hinge arm 422 on opposite sides of hinge case 412. In one example, first hinge arm 420 may include a first portion 704 that can be secured to main body 402 and a second portion 706 perpendicular to first portion 704 to engage with first sliding member 416.

Hinge case 412 may include opening 702 to receive a shaft feature 708 of second hinge arm 422 such that second hinge arm 422 may rotate inside hinge case 412. Also, hinge case 412 may include a circular shape 710 (e.g., having diameter greater than opening 702) on opposite sides to make first hinge arm 420 and second hinge arm 422 rotate inside hinge case 412. In some examples, first hinge arm 420 and second hinge arm 422 may include circular shafts 712 and 714, respectively, that can be received in circular shape 710 so that first hinge arm 420 and second hinge arm 422 can be able to rotate inside hinge case 412.

Further, as shown in FIG. 7, hinge case may include a first groove feature 716 and a second groove feature (e.g., opposite to first groove feature 716) to unrotatably support first sliding member 416 and second sliding member 418, respectively. During rotation of first hinge arm 420 relative to hinge case 412, first sliding member 416 may move horizontally in first groove feature 716. During rotation of second hinge arm 422 relative to hinge case 412, second sliding member 418 may move horizontally in the second groove feature.

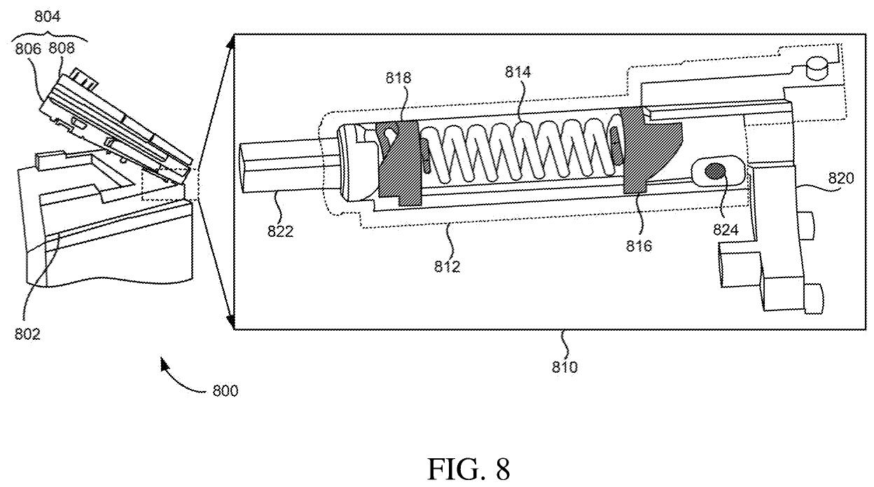

FIG. 8 is a schematic diagram of another example image forming apparatus 800 including a hinge assembly 810 to rotatably couple scanner assembly 806 and a cover member 808 to a main body 802. As shown in FIG. 8, image forming apparatus 800 may include main body 802 and an upper unit 804 rotatably connected to main body 802.

Upper unit 804 may include scanner assembly 806 and cover member 808 disposed on top of scanner assembly 806 to cover a top section of scanner assembly 806 including a flat-bed plane. Further, image forming apparatus 800 may include hinge assembly 810 to pivotally connect scanner assembly 806 and cover member 808 to main body 802. In one example, hinge assembly 810 may include a hinge case 812 secured to scanner assembly 806. Further, hinge assembly 810 may include an elastic member 814 disposed in hinge case 812. Furthermore, hinge assembly 810 may include first and second sliding members 816 and 818 disposed in hinge case 812 and physically engaged with elastic member 814 on opposite sides.

Further, hinge assembly 810 may include a first hinge arm 820 secured to main body 802 and engaged with first sliding member 816. Also, hinge assembly 810 may include a second hinge arm 822 secured to cover member 808 and engaged with second sliding member 818. In addition, hinge assembly 810 may include a hinge pin 824 engaged with hinge case 812 and first hinge arm 820 to restrain a horizontal movement of first hinge arm 820 and enable rotation of first hinge arm 820 relative to hinge case 812.

In one example, hinge case 812 may unrotatably support first and second sliding members 816 and 818 such that first and second sliding members 816 and 818 rotate along with hinge case 812. Further, hinge case 812 may rotatably support first hinge arm 820 and second hinge arm 822 such that first hinge arm 820 and second hinge arm 822 can rotate relative to hinge case 812.

During closing of upper unit 804 relative to main body 802, first sliding member 816 may move horizontally to generate an elastic force via compression of elastic member 814. During closing of upper unit 804 relative to main body 802, elastic member 814 may get compressed to generate a rotational force in the opposite direction. Thus, during closing of upper unit 804, elastic member 814 may be in the energy storage state and hinge assembly 810 may provide a torque to support a hinge up weight (e.g., a weight of upper unit 804) for no free down.

During opening of upper unit 804, the elastic potential energy (i.e., the stored energy) may be converted into the rotational kinetic energy (i.e., the rotational force) of elastic member 814 to assist in opening of upper unit 804 so that the force involved for opening may be light. Thus, elastic member 814 may generate rotational/opening force, which may cause upper unit 804 to open relative to main body 802, and hence opening of upper unit 804 may become light.

During the closing of cover member 808 relative to scanner assembly 806, second sliding member 818 may move horizontally to generate an elastic force via compression of elastic member 814. During closing of cover member 808, elastic member 814 may get compressed to generate a rotational force in the opposite direction. Thus, during closing of cover member 808, elastic member 814 may be in the energy storage state and hinge assembly 810 may provide a torque to support a hinge up weight (e.g., a weight of cover member 808) for no free down.

During opening of cover member 808, the elastic potential energy (i.e., the stored energy) may be converted into the rotational kinetic energy (i.e., the rotational force) of elastic member 814 to assist in opening of cover member 808 so that the force involved for opening may be light. Thus, elastic member 814 may generate rotational/opening force, which may cause cover member 808 to open relative to main body 802, and hence opening of upper unit 804 may become light.

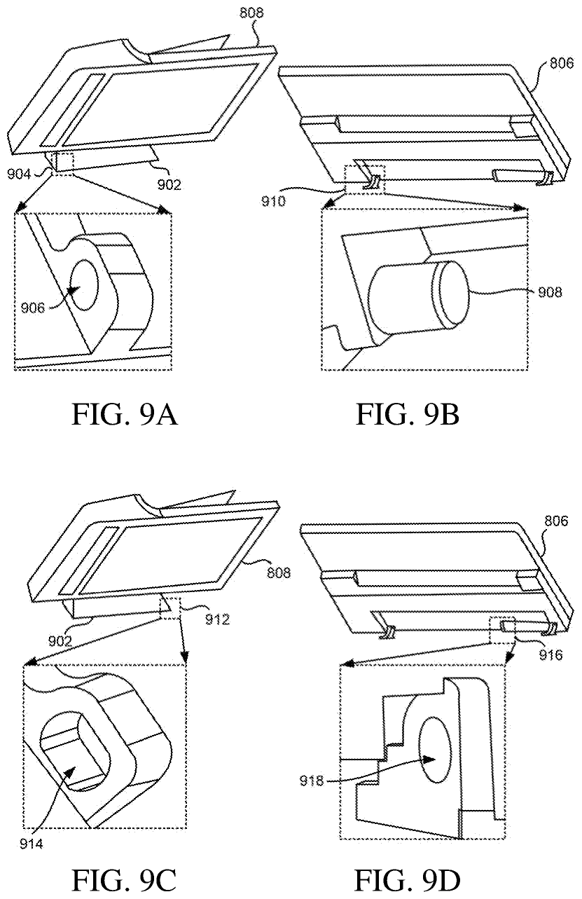

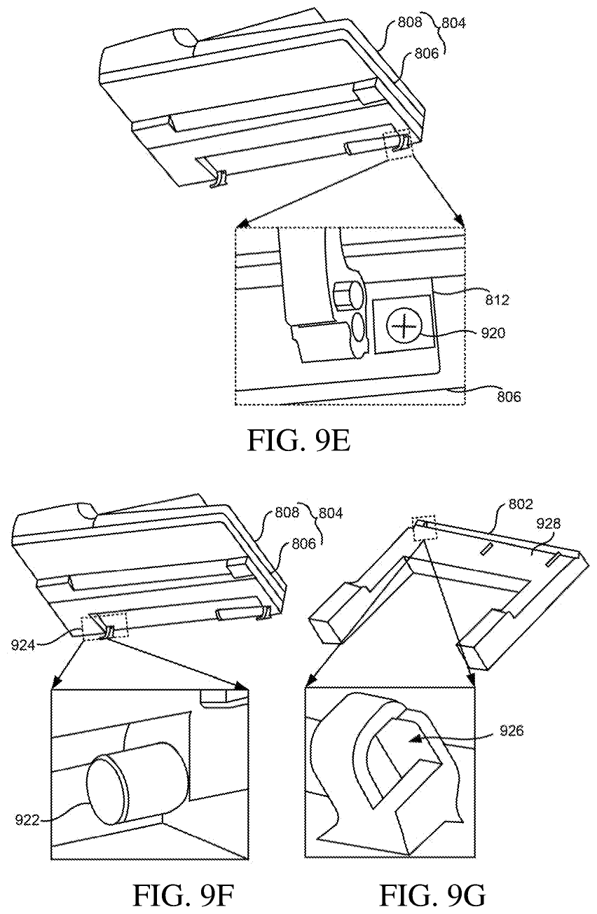

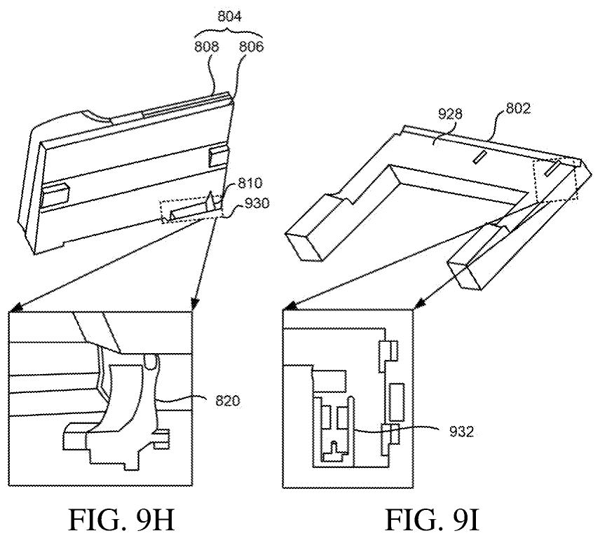

FIGS. 9A-9I depict an example installation mechanism of hinge assembly 810 and image forming apparatus 800 of FIG. 8 including upper unit 804 and main body 802. For example, similarly named elements of FIGS. 9A-9I may be similar in structure and/or function to elements described with respect to FIG. 8. FIG. 9A depicts cover member 808 including a downwardly protruding portion 902 that can be secured to second hinge arm (e.g., second hinge arm 822 of FIG. 8). As shown in FIG. 9A, one end 904 of protruding portion 902 may include an opening 906. FIG. 9B depicts scanner assembly 806 including a shaft feature 908 at one end 910 to mate with opening 906 defined in protruding portion 902 of cover member 808. As shown in FIG. 9C, another end 912 of protruding portion 902 may include a slotted opening 914. As shown in FIG. 9D, another end 916 of scanner assembly 806 may include an opening 918.

In one example, second hinge arm 822 may be received through slotted opening 914 of cover member 808 and opening 918 of scanner assembly 806 such that second hinge arm 822 can rotate along with cover member 808. In this example, cover member 808 may fixedly hold second hinge arm 822 while scanner assembly 806 may rotatably hold second hinge arm 822. Thus, cover member 808 may be assembled on scanner assembly 806 to form upper unit 804. FIG. 9E depicts example upper unit 804 including scanner assembly 806 connected to hinge assembly 810. As shown in FIG. 9E, hinge case 812 may be connected to scanner assembly 806, for instance, using a screw 920. Thus, hinge assembly 810 may be assembled to upper unit 804.

FIG. 9F depicts an example upper unit 804 having a shaft feature 922 at one end 924. FIG. 9G depicts an example main body 802 having an opening 926 in a top cover 928 of main body 802. Shaft feature 922 of upper unit 804 may be received in opening 926 of main body 802 to connect one end 924 of upper unit 804 to main body 802.

FIG. 9H depicts example upper unit 804 having hinge assembly 810 at another end 930. FIG. 9I depicts example main body 802 having a fixing structure 932 on top cover 928 of main body 802. First hinge arm 820 of hinge assembly 810 can be connected to fixing structure 932 to connect other end 930 of upper unit 804 to main body 802. Thus, upper unit 804 may be connected to main body 802 via hinge assembly 810.

It may be noted that the above-described examples of the present solution are for the purpose of illustration. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

1. A hinge assembly for an image forming apparatus comprising:
a hinge case;
an elastic member disposed in the hinge case;
a first sliding member to engage with a first side of the elastic member;
a second sliding member to engage with a second side of the elastic member;
a first hinge arm to engage with the first sliding member such that the first sliding member is to compressively engage with the elastic member during rotation of the first hinge arm relative to the hinge case; and
a second hinge arm to engage with the second sliding member such that the second sliding member is to compressively engage with the elastic member during rotation of the second hinge arm relative to the hinge case.

2. The hinge assembly of claim 1, wherein the hinge case comprises:
first and second groove features on opposite sides of the hinge case.

3. The hinge assembly of claim 2, wherein the first and second sliding members comprise first and second protruding features, respectively, wherein the first protruding feature is to mate with the first groove feature such that the first sliding member is to slide horizontally within the hinge case during rotation of the first hinge arm, and wherein the second protruding feature is to mate with the second groove feature such that the second sliding member is to slide horizontally within the hinge case during rotation of the second hinge arm.

4. The hinge assembly of claim 1, wherein the first hinge arm and the first sliding member comprise a first sliding feature and a second sliding feature, respectively, wherein the first hinge arm is to physically engage with the first sliding member via the first sliding feature and the second sliding feature.

5. The hinge assembly of claim 1, wherein the second hinge arm and the second sliding member comprise a third sliding feature and a fourth sliding feature, respectively, wherein the second hinge arm is to physically engage with the second sliding member via the third sliding feature and the fourth sliding feature.

6. An image forming apparatus comprising:
a main body;
an upper unit comprising:
a scanner assembly; and
a cover member disposed on the scanner assembly; and
a hinge assembly to pivotally connect the scanner assembly and the cover member to the main body, the hinge assembly comprising:
a hinge case secured to the scanner assembly;
an elastic member disposed in the hinge case;
first and second sliding members engaged with the elastic member on opposite sides;
a first hinge arm secured to the main body and engaged with the first sliding member; and
a second hinge arm secured to the cover member and engaged with the second sliding member.

7. The image forming apparatus of claim 6, wherein the first hinge arm and the first sliding member comprise a first sliding feature and a second sliding feature, respectively, wherein the first hinge arm is physically engaged with the first sliding member via the first sliding feature and the second sliding feature such that the elastic member is to generate an elastic force to hold the upper unit in an open position.

8. The image forming apparatus of claim 6, wherein the second hinge arm and the second sliding member comprise a third sliding feature and a fourth sliding feature, respectively, wherein the second hinge arm is physically engaged with the second sliding member via the third sliding feature and the fourth sliding feature such that the elastic member is to generate an elastic force to hold the cover member in an open position.

9. The image forming apparatus of claim 6, wherein the hinge case comprises:
an opening to rotatably support the first hinge arm and the second hinge arm; and
first and second groove features to unrotatably support the first and second sliding members, respectively, wherein the first sliding member is to move horizontally in the first groove feature during rotation of the first hinge arm relative to the hinge case, and wherein the second sliding member is to move horizontally in the second groove feature during rotation of the second hinge arm relative to the hinge case.

10. The image forming apparatus of claim 6, wherein the first hinge arm comprises:
a first portion secured to the main body; and
a second portion perpendicular to the first portion to engage with the first sliding member.

11. An image forming apparatus comprising:
a main body;
an upper unit comprising:
a scanner assembly; and
a cover member disposed on the scanner assembly; and
a hinge assembly to pivotally connect the scanner assembly and the cover member to the main body, the hinge assembly comprising:
a hinge case secured to the scanner assembly;
an elastic member disposed in the hinge case;
first and second sliding members engaged with the elastic member on opposite sides;
a first hinge arm secured to the main body and engaged with the first sliding member;
a second hinge arm secured to the cover member and engaged with the second sliding member; and
a hinge pin engaged with the hinge case and the first hinge arm to restrain a horizontal movement of the first hinge arm.

12. The image forming apparatus of claim 11, wherein the hinge case and the first hinge arm comprise an opening and an elongated vertical opening, respectively, and wherein the hinge pin is engaged with the hinge case and the first hinge arm via the opening and the elongated vertical opening, respectively, to enable rotation of the first hinge arm relative to the hinge case.

13. The image forming apparatus of claim 11, wherein the hinge case is to unrotatably support the first and second sliding members and rotatably support the first hinge arm and the second hinge arm.

14. The image forming apparatus of claim 11, wherein the first sliding member is to move horizontally to generate an elastic force via compression of the elastic member during closing of the upper unit relative to the main body.

15. The image forming apparatus of claim 11, wherein the second sliding member is to move horizontally to generate an elastic force via compression of the elastic member during the closing of the cover member relative to the scanner assembly.
